(19) United States
(12) Patent Application Publication
(10) Pub. No.: US 2014/0244984 A1
(43) Pub. Date: Aug. 28, 2014

(54) ELIGIBLE STORE MAPS FOR STORE-TO-LOAD FORWARDING

(71) Applicant: David A. Kaplan, Austin, TX (US)

(72) Inventor: David A. Kaplan, Austin, TX (US)

(73) Assignee: Advanced Micro Devices, Inc., Sunnyvale, CA (US)

(21) Appl. No.: 13/777,876

(22) Filed: Feb. 26, 2013

(51) Int. Cl. G06F 9/30

(52) U.S. Cl. CPC G06F 9/30043
USPC 712/225

(57) ABSTRACT

The present invention provides a method and apparatus for generating eligible store maps for store-to-load forwarding. Some embodiments of the method include generating information associated with a load instruction in a load queue. The information indicates whether one or more store instructions in a store queue is older than the load instruction and whether the store instruction(s) overlap with any younger store instructions in the store queue that are older than the load instruction. Some embodiments of the method also include determining whether to forward data associated with a store instruction to the load instruction based on the information. Some embodiments of the apparatus include a load-store unit that implements embodiments of the method.

### BACKGROUND

This application relates generally to processing systems, and, more particularly, to store-to-load forwarding in processing systems.

Processing systems utilize two basic memory access instructions: a store instruction that writes information from a register to a memory location and a load instruction that reads information out of a memory location and loads the information into a register. High-performance out-of-order execution microprocessors can execute load and store instructions out of program order. For example, a program code may include a series of memory access instructions including load instructions (L1, L2, . . . ) and store instructions (S1, S2, . . . ) that are to be executed in the order: S1, L1, S2, L2, . . . . However, the out-of-order processor may select the instructions in a different order such as L1, L2, S1, S2, . . . . Some instruction set architectures (e.g. the x86 instruction set architecture) require strong ordering of memory operations. Generally, memory operations are strongly ordered if they appear to have occurred in the program order specified. When attempting to execute instructions out of order, the processor must respect true dependencies between instructions because executing load instructions and store instructions out of order can produce incorrect results if a dependent load/store pair was executed out of order. For example, if (older) S1 stores data to the same physical address that (younger) L1 subsequently reads data from, the store S1 must be completed (or retired) before L1 is performed so that the correct data is stored at the physical address for L1 to read.

Store and load instructions typically operate on memory locations in one or more caches associated with the processor. Values from store instructions are not committed to the memory system (e.g., the caches) immediately after execution of the store instruction. Instead, the store instructions, including the memory address and store data, are buffered in a store queue so they can be written in-order. Eventually, the store commits and the buffered data is written to the memory system. Buffering store instructions until and in some cases after retirement can be used to help reorder store instructions so that they can commit in order. However, buffering store instructions can introduce other complications. For example, a load instruction can read an old, out-of-date value from a memory address if a store instruction executes and buffers data for the same memory address in the store queue and the load attempts to read the memory value before the store instruction has retired.

A technique called store-to-load forwarding can provide data directly from the store queue to a requesting load. For example, the store queue can forward data from completed but not-yet-committed (“in-flight”) store instructions to later (younger) load instructions. The store queue in this case functions as a Content-Addressable Memory (CAM) that can be searched using the memory address instead of a simple FIFO queue. When store-to-load forwarding is implemented, each load instruction searches the store queue for in-flight store instructions to the same address. The load instruction can obtain the requested data value from a matching store instruction that is logically earlier in program order (i.e. older). If there is no matching store instruction, the load instruction can access the memory system to obtain the requested value as long as any preceding matching store instructions have been retired and have committed their values to the memory.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

As discussed herein, store-to-load forwarding (STLF) can be used to provide data directly from a store queue to a requesting load instruction in a load queue. For example, the store queue can forward data from completed but not-yet-committed (“in-flight”) store instructions to later (younger) load instructions. When conventional STLF is implemented, each load instruction searches through all the entries in the store queue for in-flight store instructions to the same address. The load instruction can obtain the requested data value from a matching store instruction that is logically earlier in program order (i.e., older). If more than one matching store instruction is older than the load instruction, the load instruction obtains the requested data from the youngest matching store instruction that is older than the load instruction. The STLF path is typically a timing-critical path in a processing device and the time to search through the entries in the store queue increases as the size of the store queue increases. Consequently, timing requirements for the processing device may limit the size of a store queue that can implement the conventional STLF technique.

The disclosed subject matter is directed to addressing the effects of one or more of the problems set forth above.

In some embodiments, a method is provided for generating eligible store maps for store-to-load forwarding. Some embodiments of the method include generating information associated with a load instruction in a load queue. The information indicates whether one or more store instructions in a store queue is older than the load instruction and whether the store instruction(s) overlap with any younger store instructions in the store queue that are older than the load instruction. Some embodiments of the method also include determining whether to forward data associated with a store instruction to the load instruction based on the information.

In some embodiments, an apparatus is provided for generating eligible store maps for store-to-load forwarding. Some embodiments of the apparatus include a load-store unit that includes a load queue and a store queue. The load-store unit is configurable to generate information associated with a load instruction in the load queue. The information indicates whether one or more store instructions in the store queue are older than the load instruction and whether one or more store instructions overlaps with any younger store instructions in the store queue that are older than the load instruction. Some embodiments of the load-store unit are configurable to determine whether to forward data associated with a store instruction to the load instruction based on the information.

In some embodiments, a computer readable media is provided including instructions that when executed can configure a manufacturing process used to manufacture a semiconductor device for generating eligible store maps for store-to-load forwarding. Some embodiments of the semiconductor device include a load queue and a store queue. The semiconductor device is configurable to generate information associated with a load instruction in the load queue. The information indicates whether one or more store instructions in the store queue are older than the load instruction and whether one or more store instructions overlaps with any younger store instructions in the store queue that are older than the load instruction. Some embodiments of the semiconductor device are configurable to determine whether to forward data associated with a store instruction to the load instruction based on the information.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates an example of a semiconductor device that may be formed in or on a semiconductor wafer (or die), according to some embodiments;

FIG. 2 depicts an example of an eligible store map (ESM), according to some embodiments;

FIG. 3 illustrates an example of a method for maintaining an ESM such as the ESM shown in FIG. 2, according to some embodiments

FIGS. 4A-4C conceptually examples of maintaining an eligible store map (ESM) using embodiments of the method 300, according to some embodiments;

FIG. 5 shows an example of vector comparisons used to determine whether a store instruction is eligible to forward data to a load instruction, according to some embodiments; and

FIG. 6 depicts an example of a method of performing store-to-load forwarding, according to some embodiments.

While the disclosed subject matter may be modified and may take alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION

Illustrative embodiments are described below. In the interest of clarity, not all features of an actual implementation are described in this specification. It should be appreciated that in the development of any such actual embodiment, numerous implementation-specific decisions should be made, which may vary from one implementation to another. Moreover, it should be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

As discussed herein, store-to-load forwarding (STLF) is typically a timing-critical path and so the implementation of STLF may be significantly constrained by timing requirements for the processing device. The present application therefore describes embodiments of a processing device (such as a load-store unit) that can generate a first vector (which may be referred to herein as an older store map, OSM) for a load instruction in a load queue that indicates whether one or more store instructions in a store queue are older than the load instruction. A second vector may be generated for the load instruction based on the first vector. The second vector indicates whether the store instructions in the store queue are eligible to forward data to the load instruction and so the second vector may be referred to herein as an eligible store map (ESM). The second vector includes bits that can be set to indicate the store instructions in the store queue that are (1) older than the load instruction and (2) do not overlap with any younger store instructions that are older than the load instruction. The first and second vectors may therefore include a number of bits corresponding to a number of entries in the store queue, in which case a set value of a bit indicates that the corresponding entry in the store queue satisfies condition (1) for the first vector and conditions (1) and (2) for the second vector. The processing device can then use the second vector to determine whether data can be forwarded from one of the store instructions that has an address that matches an address of the load instruction.

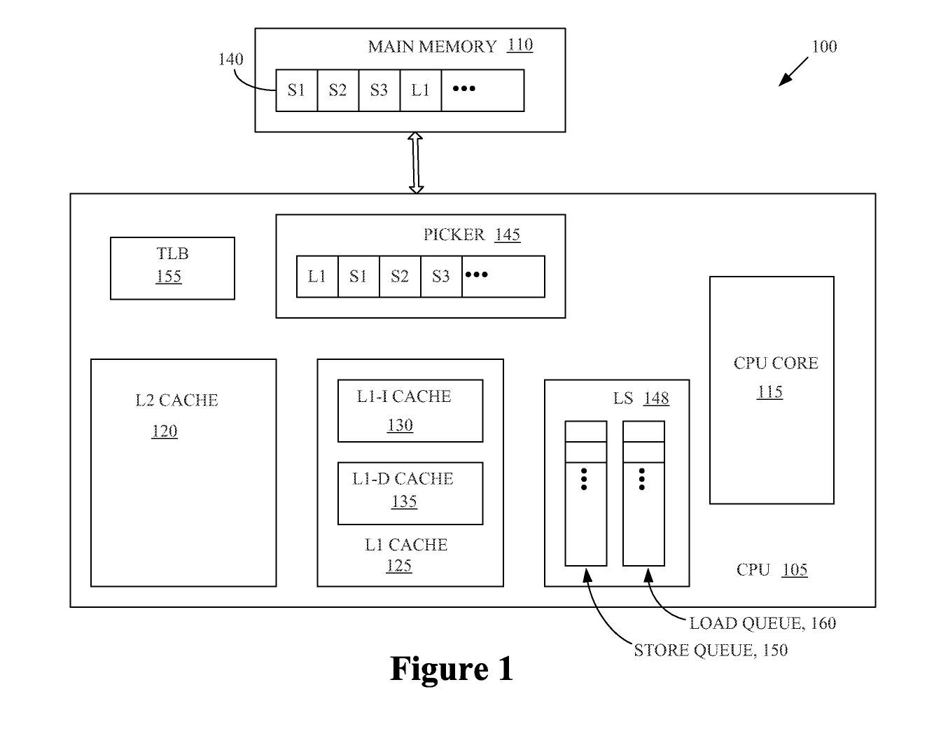

FIG. 1 conceptually illustrates an example of a semiconductor device 100 that may be formed in or on a semiconductor wafer (or die), according to some embodiments. The semiconductor device 100 may be formed in or on the semiconductor wafer using well known processes such as deposition, growth, photolithography, etching, planarizing, polishing, annealing, and the like. Some embodiments of the device 100 include a central processing unit (CPU) 105 that is configured to access instructions or data that are stored in the main memory 110. The CPU 105 includes a CPU core 115 that is used to execute the instructions or manipulate the data. The CPU 105 also implements a hierarchical (or multilevel) cache system that is used to speed access to the instructions or data by storing selected instructions or data in the caches. However, persons of ordinary skill in the art having benefit of the present disclosure should appreciate that some embodiments of the device 100 may implement different configurations of the CPU 105, such as configurations that use external caches. Some embodiments may implement different types of processors such as graphics processing units (GPUs) or accelerated processing units (APUs) and some embodiments may be implemented in processing devices that include multiple processing units or processor cores.

The cache system shown in FIG. 1 includes a level 2 (L2) cache 120 for storing copies of instructions or data that are stored in the main memory 110. Relative to the main memory 110, the L2 cache 120 may be implemented using faster memory elements and may have lower latency. The cache system shown in FIG. 1 also includes an L1 cache 125 for storing copies of instructions or data that are stored in the main memory 110 or the L2 cache 120. Relative to the L2 cache 120, the L1 cache 125 may be implemented using faster memory elements so that information stored in the lines of the L1 cache 125 can be retrieved quickly by the CPU 105. Some embodiments of the L1 cache 125 are separated into different level 1 (L1) caches for storing instructions and data, which are referred to as the L1-I cache 130 and the L1-D cache 135. Persons of ordinary skill in the art having benefit of the present disclosure should appreciate that the cache system shown in FIG. 1 is one example of a multi-level hierarchical cache memory system and some embodiments may use different multilevel caches including elements such as L0 caches, L1 caches, L2 caches, L3 caches, and the like.

The CPU core 115 can execute programs that are formed using instructions such as load instructions and store instructions. Some embodiments of programs are stored in the main memory 110 and the instructions are kept in program order, which indicates the logical order for execution of the instructions so that the program operates correctly. For example, the main memory 110 may store instructions for a program 140 that includes the stores S1, S2, S3 and the load L1 in program order. Instructions that occur earlier in program order are referred to as “older” instructions and instructions that occur later in program order are referred to as “younger” instructions. Persons of ordinary skill in the art having benefit of the present disclosure should appreciate that the program 140 may also include other instructions that may be performed earlier or later in the program order of the program 140.

Some embodiments of the CPU 105 are out-of-order processors that can execute instructions in an order that differs from the program order of the instructions in the program 140. The instructions may therefore be decoded and dispatched in program order and then issued out-of-order. As used herein, the term “dispatch” refers to sending a decoded instruction to the appropriate unit for execution and the term “issue” refers to executing the instruction. The CPU 105 includes a picker 145 that is used to pick instructions for the program 140 to be executed by the CPU core 115. For example, the picker 145 may select instructions from the program 140 in the order L1, S1, S2, which differs from the program order of the program 140 because the younger load L1 is picked before the older stores S1, S2.

The CPU 105 implements a load-store unit (LS 148) that includes one or more store queues 150 that are used to hold the store instructions and associated data. The data location for each store instruction is indicated by a linear address, which may be translated into a physical address so that data can be accessed from the main memory 110 or one of the caches 120, 125, 130, 135. The CPU 105 may therefore include a translation look aside buffer (TLB) 155 that is used to translate linear addresses into physical addresses. When a store instruction (such as S1 or S2) is picked and receives a valid address translation from the TLB 155, the store instruction may be placed in the store queue 150 to wait for data. Some embodiments of the store queue may be divided into multiple portions/queues so that store instructions may live in one queue until they are picked and receive a TLB translation and then the store instructions can be moved to another (second) queue. The second queue may be the only one that holds data for the stores. Some embodiments of the store queue 150 may be implemented as one unified queue for store instructions so that each store instruction can receive data at any point (before or after the pick).

One or more load queues 160 are implemented in the load-store unit 148 shown in FIG. 1. Load data may be indicated by linear addresses and so the linear addresses for load data may be translated into a physical address by the TLB 155. A load instruction (such as L1) may be added to the load queue 160 when the load instruction is picked and receives a valid address translation from the TLB 155. The load instruction can use the physical address (or possibly the linear address) to check the store queue 150 for address matches. If an address (linear or physical depending on the embodiment) in the store queue 150 matches the address of the data used by the load instruction, then store-to-load forwarding may be used to forward the data from the store queue 150 to the load instruction in the load queue 160.

The load-store unit 148 determines whether to allow STLF using an eligible store map (ESM, not shown in FIG. 1) that includes information that indicates whether the store instructions in the store queue 150 are eligible to forward data to a corresponding load instruction in the load queue 160. Entries in the ESM may be determined at least in part on the relative ages of load instructions in the load queue 160 and store instructions in the store queue 150. Information indicating the relative ages of the load and store instructions may be encoded in an older store map (OSM, not shown in FIG. 1). The values of entries in the ESM may also be determined at least in part by any overlaps between store instructions. For example, a 2 byte store instruction to address 0xFF would partially overlap a 4 byte store instruction from address 0x100 and consequently dependencies between these store instructions are considered when generating the ESM. Some embodiments of the ESM include a set of bits for each load instruction in the load queue 160. One or more of these bits may be set to indicate that one or more corresponding store instructions in the store queue are eligible for STLF because the corresponding store instructions are (1) older than the load instruction and (2) do not overlap with any younger store instructions that are older than the load instruction.

Some embodiments of the load-store unit 148 may also apply other conditions to determine whether to perform STLF between store and load instructions in the queues 150, 160. For example, STLF may be used to forward data when the data block in the store queue 150 encompasses the requested data blocks. This may be referred to as an “exact match.” For example, when the load instruction is a 4 byte load from address 0x100, an exact match may be a 4 byte store to address 0x100. However, a 2 byte store instruction to address 0xFF would not be an exact match because it does not encompass the 4 byte load instruction from address 0x100 even though it partially overlaps the load instruction. A 4 byte store instruction to address 0x101 would also not encompass the 4 byte load instruction from address 0x100. However, when the load instruction is a 4 byte load from address 0x100, an 8 byte store instruction to address 0x100 may be forwarded to the load instruction because it is “greater” than the load and fully encompasses the load. Some embodiments may apply other criteria such as requiring that the load instruction and the store instruction both be cacheable and neither of the instructions can be misaligned.

Some embodiments of the load-store unit 148 may block an STLF if a store instruction is ready to forward data to a load instruction but the store instruction has not received the data so it cannot forward the data. The CPU 105 may therefore identify stores that are partially qualified for STLF because of an address match between the load instruction and the store instruction but are not fully qualified for STLF because the store instruction does not have the requested data. Some embodiments of store queue 150 may associate entries with information (which may be referred to as a data-valid, or DataV, term) that indicates whether the corresponding store instruction has valid data. For example, the STLF calculations may determine whether a store instruction is fully qualified for STLF by verifying that the addresses of the load instruction and the store instruction match and the store instruction has valid data.

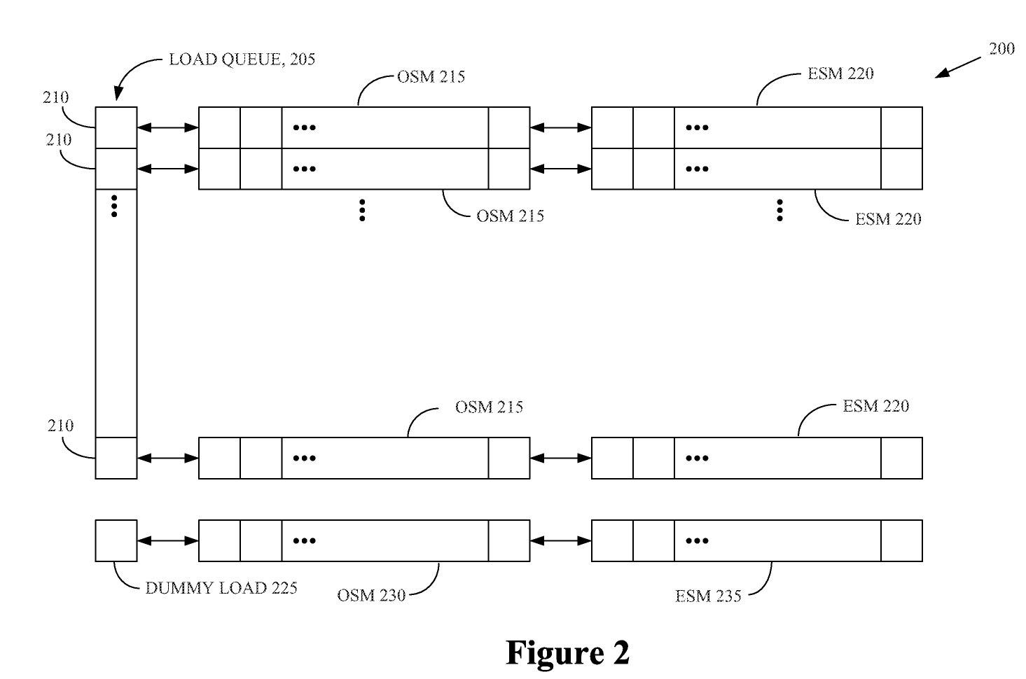

FIG. 2 depicts an example of an ESM 200, according to some embodiments. The ESM 200 shown in FIG. 2 includes a load queue 205 that can store load instructions in entries 210. Embodiments of the load queue 205 may be used to implement the load queue 160 shown in FIG. 1. Each entry 210 in the load queue 205 is associated with an OSM 215 and an ESM 220. The OSM 215 or the ESM 220 may be implemented as part of the load queue 205 or in a separate structure. The OSM 215 and the ESM 220 include vectors of bits and the number of bits in the vector corresponds to a number of entries in a corresponding store queue, such as the store queue 150 shown in FIG. 1.

Bits in the OSM 215 may be set to indicate that the corresponding store instruction in the store queue is older than the load instruction in the corresponding entry 210 of the load queue 205. Some embodiments of the OSM 215 may be a map of older store instructions that is latched when the corresponding load instruction dispatches. For example, entries in the store queue may be known at dispatch time and the corresponding load-store unit (such as the load-store unit 148 shown in FIG. 1) may maintain a bit vector that indicates the store instructions that are in the machine every cycle When a load instruction is dispatched, the load-store unit may take a snapshot of this bit vector and store this information in the OSM 215. The OSM 215 shown in FIG. 2 is mostly static as it only updates when store instructions leave the load-store unit, either by committing from the store queue. When the store instruction commits or retires, bits associated with the store instruction may be removed or cleared from the OSM 215 or the ESM 220, as discussed herein. Some embodiments of the store queue may be ordered and so some embodiments of the OSM 215 can be represented (in part) as an entry pointer to the store queue when the load is dispatched. In this case, the OSM 215 can then be created on the fly using the entry pointer and one or more wrap bits.

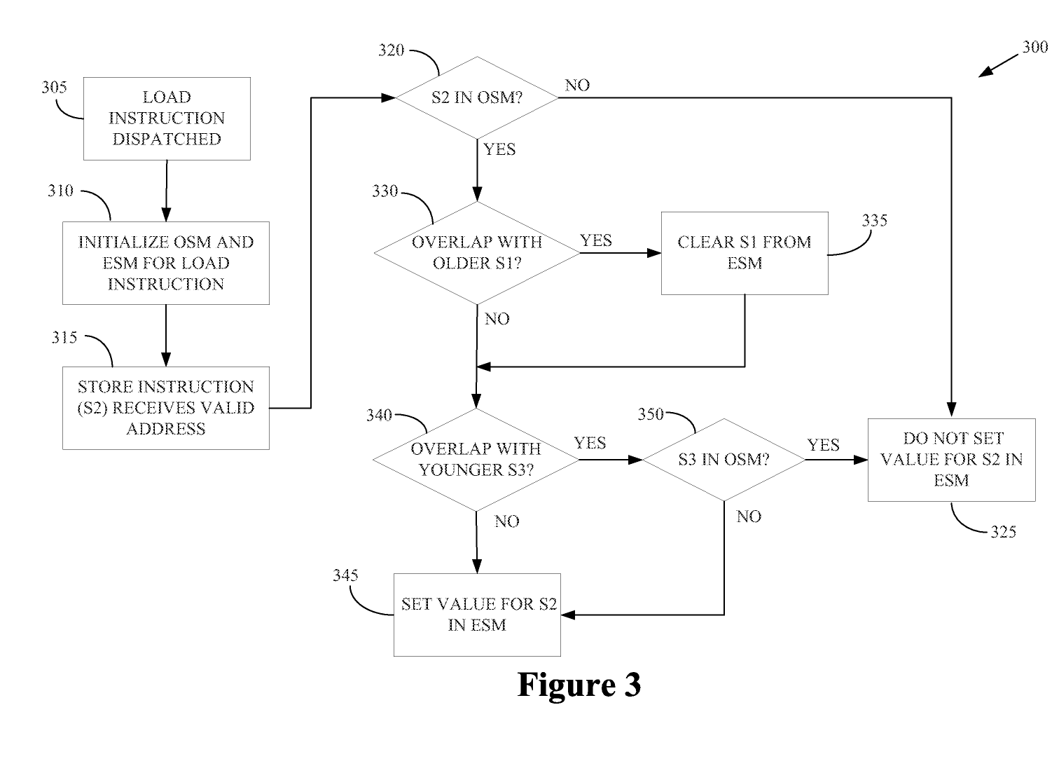

Bits in the ESM 220 for each load instruction may be set to indicate whether a corresponding store instruction is eligible for STLF to the load instruction. Maintenance of the ESM 220 may take into account address overlap, store age, or other factors and may be performed outside of the critical path of the processing device that implements the ESM 220 such as the load-store unit 148 shown in FIG. 1. Maintenance of the ESM 220 may be performed in response to a new store instruction (S2) receiving a valid address translation and being written into the store queue, e.g. as discussed herein with regard to FIG. 3. The address of the store instruction (S2) may be compared with every other store instruction in the store queue for an overlap using the address of the store instruction and a mask indicating a length associated with the store instruction. If the store instruction (S2) matches an existing entry in the store queue that is older (e.g., the store instruction S1), then the older store instruction S1 is no longer eligible for STLF to the load instruction if S2 is older than the load instruction, e.g., as indicated by the corresponding bit in the OSM 215. The bit in the ESM 220 corresponding to the store instruction S1 should therefore be invalidated, e.g., by setting the value of the bit to 0. If the store instruction (S2) matches an existing entry in the store queue that is younger (e.g., the store instruction S3), then the store instruction S2 is eligible for STLF to the load instruction if S3 is not older than the load instruction, e.g., as indicated by the corresponding bit in the OSM 215, and S2 is older than the load instruction as indicated by the corresponding bit in the OSM 215. The bit in the ESM 220 corresponding to the store instruction S2 should therefore be set. If the store instruction (S2) does not match any existing younger entries in the store queue and S2 is older than the load instruction as indicated by the corresponding bit in the OSM 215, then the store instruction S2 is eligible for STLF to the load instruction and the corresponding bit in the ESM 220 should be set. Some embodiments of the store instructions S1 and S3 above may represent multiple stores that overlap.

Some embodiments of the load queue 200 include a dummy load 225 that does not correspond to any actual load instructions. The dummy load 225 may be associated with an OSM 230 and/or an ESM 235. The dummy load 225 may be assumed to be younger than all of the stores in the store queue and so the bits in the OSM 230 that correspond to valid store instructions may be set or all the bits may be set, e.g., the values of all of the bits in the OSM 230 may be set to 1. However, since the dummy load 225 may be assumed to be younger than all of the stores in the store queue, some embodiments of the load queue 200 may not include an OSM 230 for storing the bits and may instead calculate the values of the bits as needed. The ESM 235 may be maintained in the same manner as discussed herein with regard to the ESM 220, with the difference that the OSM 230 always indicates that the dummy load 225 is younger than all of the store instructions in the store queue. When a load instruction is dispatched, the corresponding ESM 220 may be initialized by copying values of the bits in the ESM 235 to the corresponding ESM 220 for the load instruction. The corresponding OSM 215 may also be initialized by copying values of the bits in the OSM 230 to the corresponding OSM 215 for the load instruction

FIG. 3 illustrates an example of a method 300 for maintaining an ESM such as the ESM 220 shown in FIG. 2, according to some embodiments. Embodiments of the method 300 may be implemented by processing devices such as the load-store unit 148 or the semiconductor device 100 shown in FIG. 1. The method 300 illustrates embodiments of a technique for maintaining the ESM associated with a particular load instruction. However, persons of ordinary skill in the art having benefit of the present disclosure should appreciate that embodiments of the method 300 may be used to maintain ESMs associated with each load instruction in a load queue, such as the load queue 160 shown in FIG. 1 or the load queue 205 shown in FIG. 2

The method 300 begins when a load instruction is dispatched (at 305) and placed in an entry of a load queue. The load-store unit may then initialize (at 310) an OSM and an ESM (such as the OSM 215 and the ESM 220 shown in FIG. 2) for the load instruction. For example, dispatch of the load and store instructions may occur in program order and so the OSM may be initialized (at 310) using a snapshot of a bit vector that indicates the store instructions that are already in the store queue when the load instruction is dispatched. Some embodiments of the method may use other techniques such as program counters or timestamps to determine the relative ages of the instructions, e.g., for embodiments that may dispatch instructions out of program order. The ESM may be initialized (at 310) using a dummy or initial ESM that is maintained for a dummy load that is assumed to be younger than every store instruction, as discussed herein.

A store instruction (s2) receives (at 315) a valid address, e.g., from a translation lookaside buffer (TLB) or address generation unit. The load-store unit may then determine (at 320) whether the store instruction (s2) is older than the load instruction. For example, the load-store unit may examine the bits in the OSM to determine whether the bit associated with the store instruction (s2) is set to indicate that the store instruction (s2) is older than the load instruction. If not, the store instruction is not eligible for STLF to the load instruction and a value of a corresponding bit in the ESM is invalidated or not set (at 325). If the store instruction (s2) is older than the load instruction, the load-store unit determines (at 330) whether a portion of the store instruction (s2) overlaps with any older store instructions (s1). Only the youngest of any overlapping store instructions is eligible for STLF to the load instruction. Thus, if the store instruction (s2) overlaps with one or more older store instructions (s1), bits corresponding to the older store instructions (s1) are cleared (at 335) in the ESM.

The load-store unit also determines (at 340) whether the store instruction (s2) overlaps with any younger store instructions (s3). If not, the store instruction (s2) is the youngest store instruction that is also older than the load instruction and so the value of the bit in the ESM corresponding to the store instruction (s2) is set (at 345). If the store instruction (s2) overlaps with one or more younger store instructions (s3), then the load-store unit determines (at 350) whether one or more of the younger store instructions (s3) is older than the load instruction, e.g., as indicated by the bits in the OSM. If not, the store instruction (s2) is the youngest store instruction that is also older than the load instruction and so the value of the bit in the ESM corresponding to the store instruction (s2) is set (at 345). If so, the store instruction (s2) overlaps with at least one younger store instruction (s3) that is also older than the load instruction and so the store instruction is not eligible for STLF to the load instruction. A value of a bit in the ESM corresponding to the store instruction (s2) is not set (at 325).

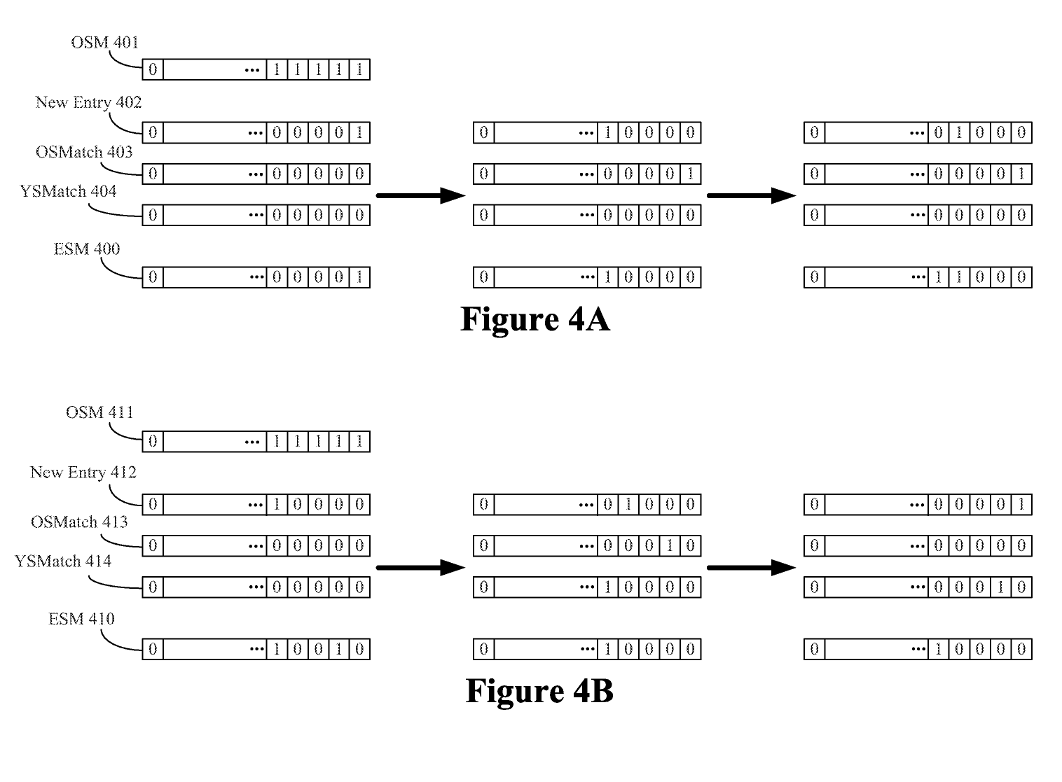

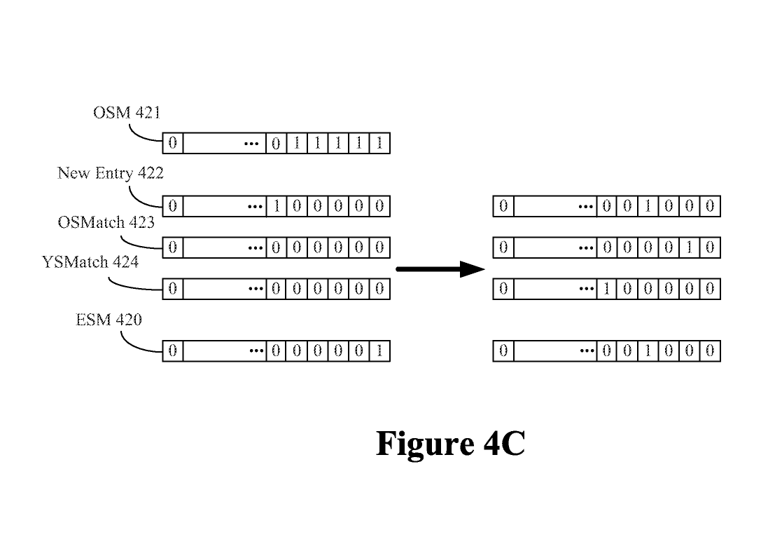

FIGS. 4A-4C conceptually illustrates examples of maintaining an eligible store map (ESM) using embodiments of the method 300, according to some embodiments. The illustrated examples are for an ESM 400 associated with a load instruction with an initial OSM 401 of 0x1f (i.e., 5 older stores). The ESM 400 is initially set to 0. The store instructions in the store queue that are older than the load instruction are referred to herein as S0-4 where S0 is the oldest store instruction and S4 is the youngest store instruction in the store queue when the load instruction is dispatched. Some embodiments may define one or more additional vectors for maintaining the ESM 400. For example, a one-hot vector NewEntry 402 may be used to indicate a new store queue entry that is being written in the current cycle, a multi-hot vector OSMatch 403 may be used to indicate store queue entries that are older than the new store instruction and overlap with the new store instruction, and another multi-hot vector YSMatch 404 may be used to indicate store queue entries that are younger than the new store instruction and overlap with the new store instruction.

FIG. 4A depicts an example in which store instruction S0 is a 4B store to address 0x10 and is written to the store queue first. When the store instruction S0 is written to the store queue and so the first bit in the vector NewEntry 402 is set. There are no other store instructions in the store queue at this time so that of the bits in the vector OSMatch 403 or the vector YSMatch 404 are set. The store instruction S0 is older than the load instruction and does not overlap with any older or younger store instructions. Consequently, the bit 0 in the ESM 400 for the load instruction is set to indicate that S0 is eligible for STLF to the load instruction.

The store instruction S4 is subsequently written to the store queue and the store instruction S4 is a 4B store to address 0x12. The address of the store instruction S4 overlaps with the store instruction S0 and so when the store instruction S4 is written to the store queue, bit 4 in the vector NewEntry 402 is set and the first bit in the vector OSMatch 403 is set since S4 overlaps with S0. The store instruction S4 is in the OSM 401 for the load instruction and is younger than the store instruction S0. Consequently, bit 0 in the ESM 400 for the load instruction is cleared or invalidated to indicate that the store instruction S0 is no longer eligible for STLF to the load instruction. The store instruction S4 does not overlap with any younger store instructions and so bit 4 in the ESM 400 for the load instruction is set.

The store instruction S3 is a 4B store to address 0x20 that is subsequently written to the store queue. The store instruction S3 doesn't overlap with any existing store instructions and so the store instruction is eligible for STLF to the load instruction. Bit 3 in the ESM 400 for the load instruction may therefore be set. If the load instruction were issued at this point, bits 3 and 4 in the ESM 400 are set indicating that if the load instruction matches address 0x12 or 0x20, it can receive forwarded data from the corresponding store instruction.

FIG. 4B depicts an example in which the store instruction S1 is a 4B store to address 0x10 that is the first store instruction written to the store queue. The store instruction S4 is a 4B store to address 0x14 that is subsequently written to the store queue. The store instructions S1 and S4 do not overlap and so at this point bits 1 and 4 in the ESM 410 are set.

The store instruction S2 is a 4B store to address 0x12 that is subsequently written to the store queue. The store instruction S2 overlaps with both store instructions S1 and S4. Consequently, bit 2 in the vector NewEntry 412 is set, bit 2 in the vector OSMatch 413 is set, and bit 4 in the vector YSMatch 414 is set. The store instruction S2 matches the older store instruction S1 and so bit 1 is cleared from the ESM 410. The store instruction S2 also matches the younger store instruction S4 and so bit 2 in the ESM 410 is not set. At this point, the bits 4 in the ESM 410 is the only bit that is set, which indicates that the store instruction S4 is the only store that can forward to the load instruction.

The store instruction S0 is a 4B store to address 0x8 that is subsequently written to the store queue. The store instruction S0 overlaps with S1, so bit 1 in the vector YSMatch 414 is set. Even though S1 is no longer in the ESM 410, it is still in the OSM 411 and so bit 0 of the ESM 400 is not set for the store instruction S0 since the store instruction S0 cannot safely forward to the load.

FIG. 4C depicts an example in which the store instruction S1 is a 4B store to address 0x10 that is written to the store queue first. The first bit in the ESM 420 is therefore set to indicate that the store instruction S1 is eligible for STLF to the load instruction. The store instruction S5 is a 4B store to address 0x14 that is younger than the load instruction (as indicated by the bit value of 0 in the OSM 421) and is subsequently written to the store queue. The bit corresponding to the store instruction S5 is not set in the OSM 421 and so the store instruction S5 is not added to the ESM 420 because the ESM 400 is strictly a subset of the OSM 421.

The store instruction S3 is a 4B store to address 0x12 that is subsequently written to the store queue. The store instruction S3 overlaps with the older store instruction S1 so bit 1 in the vector OSMatch 423 is set. The overlap between the store instructions S1 and S3 causes the ESM 420 to clear bit 1 because the store instruction S1 is no longer eligible for STLF to the load instruction because there is a younger overlapping store instruction S3 in the store queue. The store instruction S3 also overlaps with the younger store instruction S5 so bit 5 in the vector YSMatch 424 is set. Since the younger store match (S5) is not in the OSM 421, the store instruction S3 is therefore eligible for STLF to the load instruction and bit 3 in the ESM 420 may be set so that only bit 3 in the ESM 420 meaning only S3 can forward to the load instruction.

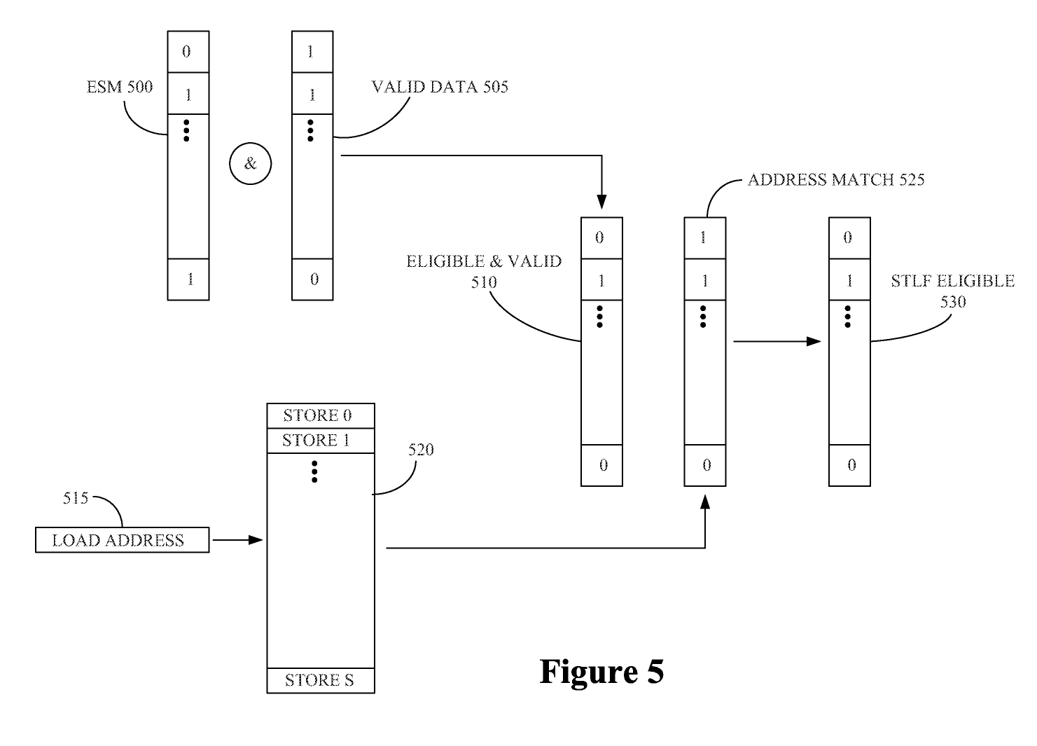

FIG. 5 shows an example of vector comparisons used to determine whether a store instruction is eligible to forward data to a load instruction, according to some embodiments. Some embodiments of the vector comparisons shown in FIG. 5 may be performed by load-store units such as the load-store unit 148 shown in FIG. 1. An ESM 500 associated with the load instruction may be accessed in response to the load instruction being picked for execution. Bits in the ESM 500 indicate whether the corresponding store instruction is eligible to forward data to the load instruction. The ESM 500 may then be compared to a valid data vector 505 that includes bits that indicate whether corresponding entries in a store queue have valid data. For example, corresponding bits in the ESM 500 and the valid data vector 505 may be AND-ed to generate a vector 510 that indicates the store instructions that have valid data and are eligible for STLF.

The address 515 for the load instruction may also be compared to the addresses of the store instructions in the store queue 520. The comparison may be performed in the load-store unit or by other functionality. A vector 525 may be generated based on the comparison and bits in the vector may be set to indicate one or more store instructions that match the load address 515. Performing the comparison and generating the vector 525 may be performed simultaneously or concurrently with comparing the ESM 500 to the valid data vector 505 and generating the vector 510 or these operations may be performed in any order. The eligible/valid vector 510 may then be combined with the address match vector 525 to generate a 0 or 1-hot vector 430 that indicates which, if any, of the store instructions are eligible for STLF. If none of the bits in the vector 530 are set, then none of the store instructions in the store queue 520 are eligible for STLF to the load instruction. If the vector 530 has one bit set, then the corresponding store instruction in the store queue 520 is eligible for STLF to the load instruction.

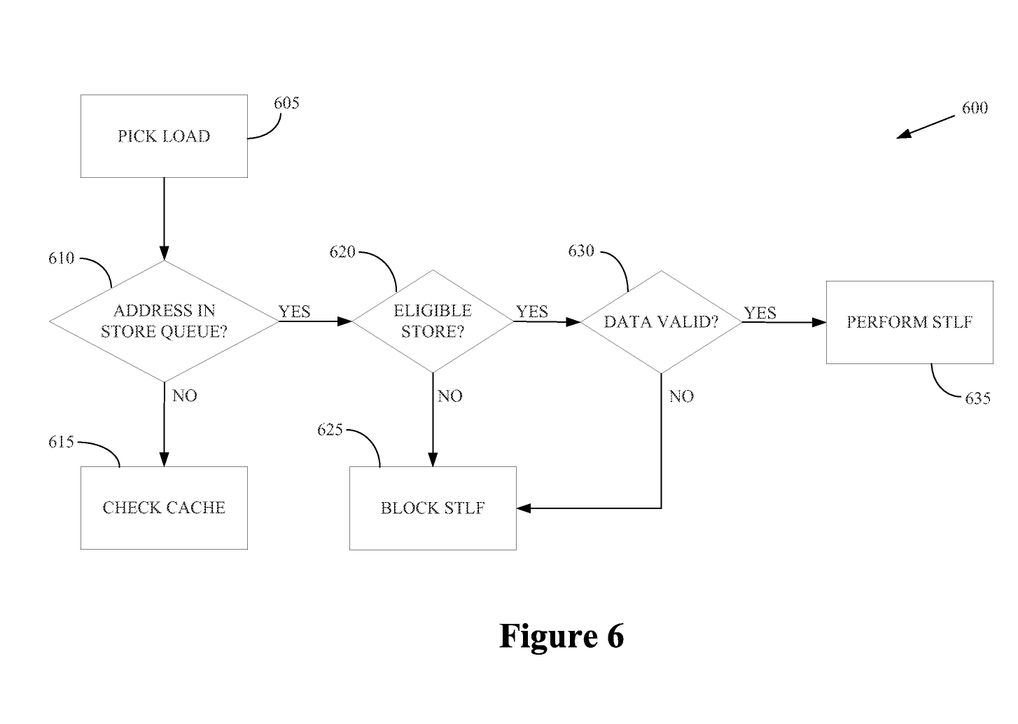

FIG. 6 depicts an example of a method 600 of performing STLF, according to some embodiments. Some embodiments of the method 600 may be implemented in a load-store unit such as the load-store unit 148 shown in FIG. 1. The load-store unit picks (at 605) a load instruction. Picking (at 605) the load instruction may include translating linear addresses into physical addresses or placing the load instruction in a load queue. The load-store unit may then use the address (linear or physical depending on the embodiment) to determine (at 610) whether the address matches a store instruction that is in a store queue such as the store queue 150 shown in FIG. 1. If the address is not in the store queue, then one or more caches can be checked (at 615) to see if the addresses indicate that data is stored in one or more of the caches, e.g. by comparing portions of the address to tags in a tag array associated with the cache. If the address is located in the store queue, then the load-store unit can determine (at 620) whether the store instruction is eligible for STLF to the load instruction by checking an ESM for the load instruction, as discussed herein. If not, then STLF from the store instruction to the load instruction is blocked and is not allowed to complete at that time (at 625).

If the store instruction is eligible for STLF to the load instruction, the validity of the data in the store queue is determined (at 630). If the store instruction indicated by the address includes valid data, then STLF can be performed (at 635) to forward the requested data from the store queue to the load instruction. If the store instruction indicated by the address does not have valid data, then STLF from the store instruction to the load instruction is blocked (at 625). Persons of ordinary skill in the art having benefit of the present disclosure should appreciate that the particular sequence of steps depicted in FIG. 6 is intended to be illustrative. Some embodiments of the method 500 may check eligibility of the store instruction (at 620) and verify (at 630) that store instructions include valid data in any order, simultaneously, or concurrently.

Some embodiment of the STLF procedures descried herein may also account for misaligns, non-fowardable store instructions, uncacheable store instructions or other factors that may affect eligibility of the store instructions for STLF. Some embodiments may include signaling to specify that a new store is not eligible to forward. For example, misaligned store instructions may not be eligible for STLF. However, the load-store unit may still perform address compares on both halves of a misaligned store instruction to determine whether other store instructions overlap with either half of the misaligned store instruction and, if so, whether the other store instructions are eligible for STLF.

Some embodiments of the techniques described herein may have a number of advantages over the conventional practice. For example, implementing an ESM to determine eligibility may reduce the size and complexity of the existing STLF logic as fewer bits need to be maintained and less random logic is needed for figuring out store eligibility. For another example, using the ESM to determine eligibility may improve the timing of the critical STLF path at least in part because the ESM may be determined before determining STLF eligibility of a particular store instruction so the STLF calculation is little more than just the address compares.

Some embodiments may also be optimized to improve power usage or performance. For example, the comparators for comparing the load address to the address of the store instruction may be constrained so that they do not fire unless the store is in the ESM thus saving power. For another example, STLF related logic may be gated off if the ESM is 0, indicating that no stores are currently eligible for STLF. For yet another example, the ESM for a load instruction may be cleared if the load goes through the pipe and is not able to receive forwarding due to no stores matching its address. Upon a new store instruction being added to the store queue, the load instruction could compare its address to the address of the new store instruction and if the address matches and the new store instruction's bit is set in the ESM, the load instruction could mark itself ready to replay. This could allow for faster replays when the store instruction's address was not known when the load instruction was originally picked. It could also allow for removing blocks that are not needed anymore.

Some embodiments may allocate entries to the store queue using a counter that ensures that the store instructions are allocated in program order. In that case, the OSM could be maintained using a head and tail pointer rather than a bit vector, which could result in bit savings in the store queue. This scheme could also be modified to support merging from multiple sources and STLF when sizes do not match. For example, instead of each store instruction having one bit in the ESM, it could have 8 bits representing each of the (potentially) 8 bytes of that store instruction. When new store instructions are added they can check for overlaps and modify the ESM based on which bytes are now eligible for forwarding. The cost of this would be increasing the size of the ESM. Some embodiments may maintain this information at a word or dword granularity and allow for some merging and using less bits.

Embodiments of processor systems that can use eligible store maps for performing STLF as described herein (such as the processor system 100) can be fabricated in semiconductor fabrication facilities according to various processor designs. In one embodiment, a processor design can be represented as code stored on a computer readable media. Exemplary codes that may be used to define or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

Furthermore, the methods disclosed herein may be governed by instructions that are stored in a non-transitory computer readable storage medium and that are executed by at least one processor of a computer system. Each of the operations of the methods may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted or executable by one or more processors.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
generating information associated with a load instruction in a load queue, said information indicating whether at least one store instruction in a store queue is older than the load instruction and whether said at least one store instruction overlaps with at least one younger store instruction in the store queue that is older than the load instruction; and
determining whether to forward data associated with said at least one store instruction to the load instruction based on said information.

2. The method of claim 1, wherein generating said information comprises generating information indicating that said at least one store instruction is eligible to forward data to the load instruction because said at least one store instruction is older than the load instruction and does not overlap with at least one younger store instruction that is older than the load instruction.

3. The method of claim 2, wherein generating said information comprises generating a first vector associated with the load instruction, wherein the first vector comprises bits associated with entries in the store queue, and wherein the bits can be set to indicate that a corresponding store instruction is older than the load instruction and does not overlap with an younger store instruction that is older than the load instruction.

4. The method of claim 3, wherein generating the first vector comprises generating the first vector based on a second vector associated with the load instruction, and wherein the second vector comprises bits that indicate whether entries in the store queue are older than the load instruction.

5. The method of claim 4, wherein generating the first vector comprises determining, in response to a first store instruction receiving a valid address, whether the first store instruction overlaps at least one older store instruction and, if so, invalidating at least one bit in the first vector corresponding to said at least one older store instruction.

6. The method of claim 5, wherein generating the first vector comprises determining whether the first store instruction overlaps at least one younger store instruction.

7. The method of claim 6, wherein a first bit in the first vector corresponding to the first store instruction is not set when at least one overlapping younger store instruction is older than the load instruction.

8. The method of claim 7, wherein the first bit is set when there are no overlapping younger store instructions or when no overlapping younger store instructions are older than the load instruction.

9. The method of claim 3, comprising generating a dummy vector for a fake load that is younger than all store instructions in the store queue, and wherein generating the first vector comprises initializing the first vector using the dummy vector.

10. The method of claim 1, comprising forwarding data associated with one of said at least one store instructions to the load instruction when addresses of the load instruction and said one of said at least one store instruction match, said one of said at least one store instruction has valid data, and said information indicates that said one of said at least one store instruction is eligible to forward data to the load instruction.

11. A load-store unit, comprising:
a load queue and a store queue, wherein the load-store unit is configurable to generate information associated with a load instruction in the load queue, said information indicating whether at least one store instruction in the store queue is older than the load instruction and whether said at least one store instruction overlaps with at least one younger store instruction in the store queue that is older than the load instruction, and wherein the load-store unit is configurable to determine whether to forward data associated with said at least one store instruction to the load instruction based on said information.

12. The load-store unit of claim 11, wherein the load-store unit is configurable to generate information indicating that said at least one store instruction is eligible to forward data to the load instruction because said at least one store instruction is older than the load instruction and does not overlap with at least one younger store instruction that is older than the load instruction.

13. The load-store unit of claim 12, comprising first bits associated with the load instruction, wherein the first bits can be set to indicate that a corresponding store instruction is older than the load instruction and does not overlap with an younger store instruction that is older than the load instruction.

14. The load-store unit of claim 13, comprising second bits associated with the load instruction, wherein the second bits can be set to indicate whether the corresponding entries in the store queue are older than the load instruction.

15. The load-store unit of claim 14, wherein the load-store unit is configurable to determine, in response to a first store instruction receiving a valid address, whether the first store instruction overlaps at least one older store instruction and, if so, the load-store unit is configurable to invalidate at least one first bit corresponding to said at least one older store instruction.

16. The load-store unit of claim 15, wherein the load-store unit is configurable to determine whether the first store instruction overlaps at least one younger store instruction.

17. The load-store unit of claim 16, wherein a first bit corresponding to the first store instruction is not set when at least one overlapping younger store instruction is older than the load instruction.

18. The load-store unit of claim 17, wherein the first bit is set when there are no overlapping younger store instructions or when no overlapping younger store instructions are older than the load instruction.

19. The load-store unit of claim 13, wherein the load-store unit is configurable to generate a dummy vector for a fake load that is younger than all store instructions in the store queue, and wherein generating the first vector comprises initializing the first vector using the dummy vector.

20. The load-store unit of claim 11, wherein the load-store unit is configurable to forward data associated with one of said at least one store instruction to the load instruction when addresses of the load instruction and said one of said at least one store instruction match, said one of said at least one store instruction has valid data, and said information indicates that said one of said at least one store instruction is eligible to forward data to the load instruction.

21. A computer readable media including instructions that when executed can configure a manufacturing process used to manufacture a semiconductor device comprising:
a load queue and a store queue, wherein the load-store unit is configurable to generate information associated with a load instruction in the load queue, said information indicating whether at least one store instruction in the store queue is older than the load instruction and whether said at least one store instruction overlaps with at least one younger store instruction in the store queue that is older than the load instruction, and wherein the load-store unit is configurable to determine whether to forward data associated with said at least one store instruction to the load instruction based on said information.

22. The computer readable media set forth in claim 21, wherein the semiconductor device further comprises first bits associated with the load instruction, wherein the first bits can be set to indicate that a corresponding store instruction is older than the load instruction and does not overlap with an younger store instruction that is older than the load instruction.

23. The computer readable media set forth in claim 22, wherein the semiconductor device further comprises second bits associated with the load instruction, wherein the second bits can be set to indicate whether the corresponding entries in the store queue are older than the load instruction.
